(19) United States
(12) Patent Application Publication
(10) Pub. No.: US 2023/0001460 A1
(43) Pub. Date: Jan. 5, 2023

(54) MANUAL LASER CLEANING DEVICE

(71) Applicant: IMT CO., LTD., Gyeonggi-do (KR)

(72) Inventors: Jongmyoung LEE, Gyeonggi-do (KR); Sungho CHO, Gyeonggi-do (KR); Hanseop CHOE, Gyeonggi-do (KR)

(21) Appl. No.: 17/784,578

(22) PCT Filed: Mar. 4, 2020
(86) PCT No.: PCT/KR2020/003068

§ 371 Date: Jun. 10, 2022

(30) Foreign Application Priority Data
Feb. 27, 2020 (KR) 10-2020-0024063

(51) Int. Cl. B08B 7/00; B23K 26/03; B23K 26/04; B23K 26/16; B23K 37/02; B23K 26/362; B08B 13/00; B08B 15/04

(52) U.S. Cl. CPC B08B 7/0042; B23K 26/03; B23K 26/048; B23K 26/16; B23K 37/0294; B23K 26/362; B08B 13/00; B08B 15/04; B23K 26/082

(57) ABSTRACT

A manual laser cleaning device for removing foreign matter present on the surface of a workpiece according to an embodiment includes a laser generator oscillating a laser beam, a controller controlling the laser generator, and a laser cleaning head receiving the laser beam emitted from the laser generator through an optical fiber and irradiating a surface of a workpiece with the received laser beam. The laser cleaning head includes a head housing having a handle, a collimator placed in the head housing and collimating the laser beam scattered at one end of the optical fiber into parallel light, a high-speed Galvano scanner scanning the laser beam transmitted through the collimator at high speed using a mirror mounted on a scanning motor, and a focal lens focusing the laser beam scanned by the high-speed Galvano scanner at a focal distance and irradiating the surface of the workpiece with the laser beam.

### CROSS REFERENCE TO RELATED APPLICATIONS AND CLAIM OF PRIORITY

This application claims benefit under 35 U.S.C. 119, 120, 121, or 365(c), and is a National Stage entry from International Application No. PCT/KR2020/003068, filed Mar. 4, 2020, which claims priority to the benefit of Korean Patent Application No. 10-2020-0024063 filed in the Korean Intellectual Property Office on Feb. 27, 2020, the entire contents of which are incorporated herein by reference.

### BACKGROUND

### 1. Technical Field

The present invention relates to a laser cleaning device for removing foreign matter from a metal surface, and more particularly to a manual laser cleaning device adapted to allow an operator to perform a laser cleaning operation with respect to a metal surface by gripping a laser cleaning head thereof.

### 2. Background Art

Various kinds of foreign matter exist on a metal surface in industrial manufacturing fields. For efficient subsequent processes, it is necessary to remove foreign matter, such as oil, rust, and oxide films, on the metal surface. In particular, in the shipbuilding and automobile industry, paints, such as epoxy and urethane, are applied to surfaces of metal members for rust prevention and protection. Upon welding between the members, the paints present in a welding area adversely affect weld quality and thus must be removed. Further, when ships or automobiles are repaired after a certain period of time, repainting operation is performed again after complete removal of the previous paint.

In general, such foreign matter (including paints and coating agents) present on the metal surface are removed by bead blasting or grinding. However, since this method causes contamination of surrounding environments and provides detrimental effects on safety of operators, various attempts have been made to apply a laser cleaning method which is more environmentally friendly and safe.

However, the laser cleaning method has been restrictively used in work sites or processes where installation and utilization of laser cleaning devices is easy, such as semiconductor production plants and the like, and it has been difficult to use the laser cleaning method at general industrial sites, such as shipbuilding and automobile industries under conditions where input and installation of the laser cleaning devices is restricted.

### SUMMARY

Accordingly, the present invention suggests a manual laser cleaning device adapted to allow an operator to perform cleaning operation with respect to a metal surface, with a laser cleaning head of the manual laser cleaning device gripped by the operator.

It is desirable that the manual laser cleaning device meet the following conditions in order to be efficiently used in general industrial fields, such as shipbuilding and automobiles.

First, the laser cleaning head is required to have a light weight to be gripped by an operator in cleaning operation.

In addition, the manual laser cleaning device focuses a laser beam on a focal plane through a focal lens in cleaning operation and is thus required to maintain a constant focal length for stable cleaning operation.

Further, when a laser beam is delivered to the surroundings of a workpiece instead of being delivered to the workpiece, there can be a significant risk to safety of operators and persons around the operators. Therefore, there is a need for a structure capable of preventing the laser beam from being delivered to the operators and persons around the operators.

Therefore, it is an object of the present invention to provide a manual laser cleaning device that allows an operator to perform efficient and safe cleaning operation with respect to a surface of a workpiece by gripping a laser cleaning head thereof.

In accordance with one aspect of the present invention, there is provided a manual laser cleaning device for removing foreign matter from a surface of a workpiece, the manual laser cleaning device including: a laser generator oscillating a laser beam; a controller controlling the laser generator; and a laser cleaning head receiving the laser beam emitted from the laser generator through an optical fiber and irradiating a surface of a workpiece (W) with the received laser beam, wherein the laser cleaning head includes: a head housing having a handle; a collimator placed in the head housing and collimating the laser beam scattered at one end of the optical fiber into parallel light; a high-speed Galvano scanner scanning the laser beam transmitted through the collimator at high speed using a mirror mounted on a scanning motor; and a focal lens focusing the laser beam scanned by the high-speed Galvano scanner at a focal distance (d) and irradiating the surface of the workpiece with the laser beam.

According to one embodiment, the laser cleaning head may include a metal detection sensor detecting whether the surface of the workpiece is a metal surface and the controller may block oscillation of the laser beam by the laser generator upon detecting that the surface of the workpiece is not the metal surface.

According to one embodiment, the laser cleaning head may further include a laser beam guide bar coupled to the head housing to guide the laser beam focused at the focal distance by the focal lens.

According to one embodiment, the laser beam guide bar may be adjustable in length according to the focal lens.

According to one embodiment, the laser beam guide bar may be provided on a side surface thereof with a dust collection port connected to a dust connection hose connected to a dust collector.

According to one embodiment, the laser cleaning head may further include a bearing wheel coupled to the laser beam guide bar and rolling along the surface of the workpiece.

According to one embodiment, the head housing may be formed of a plastic material.

According to one embodiment, the high-speed Galvano scanner may be operated in a 2D scanning manner using two scanning motors and two mirrors.

According to one embodiment, the laser generator and the controller may be integrated into one portable laser cleaning module capable of being carried by an operator through a handle or a shoulder strap, the portable laser cleaning module being connected to a power supply unit through a power cable therebetween.

According to one embodiment, the laser cleaning head may further include a protective window disposed in a region behind the focal lens to protect the focal lens and optical components placed in front of the focal lens, and the focal lens may be an f-θ lens.

According to one embodiment, the laser generator and the controller may be mounted together with the power supply unit on a movable cart.

The manual laser cleaning device according to the present invention allows an operator to perform cleaning operation with respect to a surface of a workpiece by gripping the laser cleaning head, thereby enabling easy cleaning of the surface of the workpiece under various operation conditions.

In the manual laser cleaning device according to the present invention, since the laser cleaning head is lightweight, the laser cleaning head gripped by the operator can be easily handled.

The manual laser cleaning device according to the present invention focuses a laser beam on a focal plane through a focal lens. Here, the manual laser cleaning device can maintain a constant focal distance through the laser-guide bar, thereby enabling stable cleaning operation.

The manual laser cleaning device according to the present invention is configured to prevent a laser beam from being delivered to an operator and persons around the operator, thereby securing safety of the operator.

The above and other objects, advantageous effects and advantages of the present invention will become apparent from preferable examples of the present invention described below with reference to the accompanying drawings.

### BRIEF DESCRIPTION OF THE DRAWINGS

FIG. 1 is a diagram of a manual laser cleaning device according to one embodiment of the present invention.

FIG. 2 is a diagram illustrating main components of the manual laser cleaning device according to the embodiment of the present invention.

FIG. 3 is a diagram of a manual laser cleaning device according to another embodiment of the present invention.

### DETAILED DESCRIPTION

Hereinafter, exemplary embodiments of the present invention will be described in detail with reference to the accompanying drawings. Here, terms or words used in this specification and claims should be interpreted as having meanings or concepts consistent with the technical spirit of the present invention based on the principle that the inventor can appropriately define the concept of the term in order to describe the invention in the best way. It should be noted that detailed descriptions of known functions and constructions which may unnecessarily obscure the subject matter of the present invention are omitted.

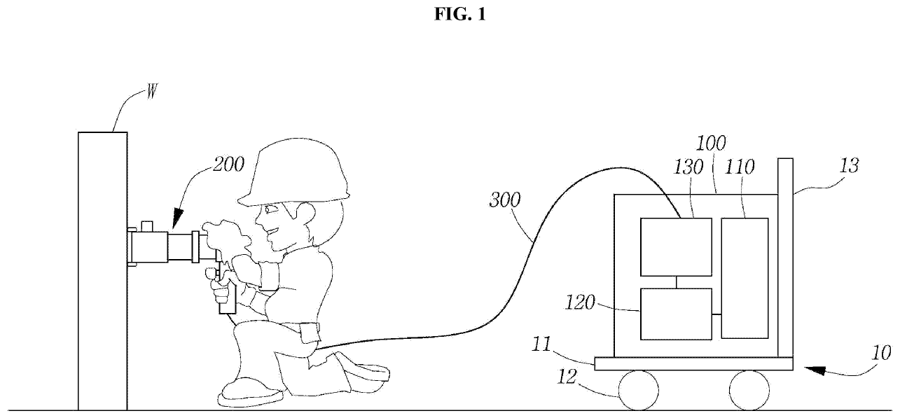

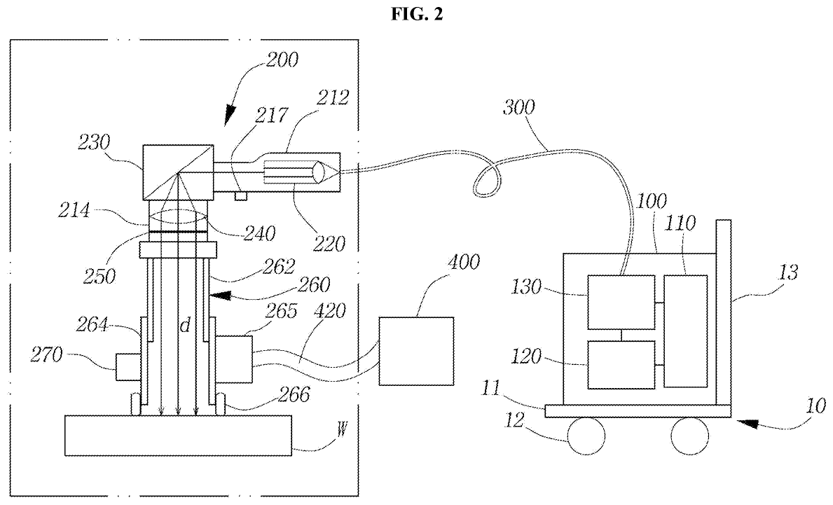

FIG. 1 is a diagram of a manual laser cleaning device according to one embodiment of the present invention and FIG. 2 is a diagram illustrating main components of the manual laser cleaning device according to the embodiment of the present invention.

Referring to FIG. 1 and FIG. 2, the manual laser cleaning device according to the embodiment of the invention is a device for cleaning a surface of a workpiece W with a laser beam and includes: a laser generator 130 adapted to oscillate a laser beam; and a laser cleaning head 200 adapted to receive the laser beam oscillated by the laser generator through an optical fiber 300 and to irradiate the surface of the workpiece W with the laser beam.

In addition, the manual laser cleaning device includes a power supply unit 110 supplying power to the laser generator 130 and a controller 120 controlling the laser generator 130. The laser generator 130, the controller 120 and the power supply unit 110 may be integrated into one main body 100. The main body 100 is mounted on a movable cart 10 to be easily moved at an industrial site. Further, the movable cart 10 includes a cart deck 11 supporting the main body 100, wheels 12 provided to a lower portion of the cart deck 11, and a cart handle 13 gripped by an operator to push and move the movable cart 10.

Upon laser cleaning with respect to the metal surface, an operator performs a laser cleaning operation while carrying the laser cleaning head 200. Then, when the manual laser cleaning device is moved to a location around the workpiece W to be cleaned or to an original location after the laser cleaning operation, the laser cleaning head 200 and the optical fiber 300 may be loaded on the movable cart 10 to be moved thereby.

On the other hand, the laser cleaning head 200 includes head housings 212, 214, a collimator 220 received in the head housings 212, 214, a high-speed Galvano scanner 230, and a focal lens 240. The head housings 212, 214 include a first head housing part 212 and a second head housing part 214 orthogonal to the first head housing part 212. In this embodiment, the first head housing part 212 acts as a handle of the laser cleaning head 200 to be gripped by an operator and may be provided therein with the laser beam collimator 220. The high-speed Galvano scanner 230 may be disposed inside a joint portion between the first head housing part 212 and the second head housing part 214 and the focal lens 240 may be disposed inside the second head housing part 214.

The laser beam oscillated by the laser generator 130 is transmitted to the collimator 220 through the optical fiber 300. The collimator 220 is connected to one end of the optical fiber 300 to collimate the laser beam scattered at the one end of the optical fiber 300 into parallel light.

The laser beam emitted from the collimator 220 is transmitted to the high-speed Galvano scanner 230. The high-speed Galvano scanner 230 is configured to perform high speed scanning with respect to the laser beam transmitted through the collimator 220 using mirrors mounted on scanning motors therein. The high-speed Galvano scanner 230 may perform one-dimensional (1D) scanning using a single scanning motor and a single mirror or two-dimensional (2D) scanning using two scanning motors and two mirrors. For more effective laser cleaning, a 2D high-speed Galvano scanner 230 adapted to perform 2D scanning using two scanning motors and two mirrors is advantageous.

The laser beam subjected to 1D or 2D scanning is focused at a certain focal distance d through the focal lens 240. Preferably, the focal lens 240 is an f-θ lens. Advantageously, the f-theta maintains a focus in a scanning region, thereby enabling uniform cleaning.

In order to protect the focal lens 240 and the mirrors inside the high-speed Galvano scanner 230, a protective window 250 is preferably disposed ahead of the focal lens 240, that is, in front of the focal lens 240 when viewed in a traveling direction of the laser beam. According to this embodiment, the protective window 250 may be disposed near a lower end of the second head housing part 214. Here, it is desirable that the protective window 250 be a consumable component. It is desirable for an operator to perform periodic cleaning with respect to a surface of the protective window 250, which is consumable, before laser cleaning.

In addition, to maintain a constant focal location of the focal lens 240, the laser cleaning head 200 includes a laser beam guide bar 260 disposed to guide the laser beam beneath the focal lens 240. The guide bar 260 is configured to allow adjustment in total height thereof and includes a stationary part 262 and a movable part 264 movably coupled to the stationary part 262 to be moved up or down. Upon laser cleaning with respect to the metal surface of the workpiece W, the guide bar 260 is disposed such that a proximal end of the guide bar 260 is coincident with a focus location of the laser beam. When the focal lens is replaced for the purpose of adjusting the intensity of the laser beam per area, the focal distance d is changed. Thus, the guide bar 260 preferably has an adjustable length.

The laser cleaning head 200 further includes a bearing wheel 266 rotatably coupled to a distal end of the guide bar 260, more specifically, to a distal end of the movable part 264 of the guide bar 260. When manual scanning is performed, the bearing wheel 266 rolls along the metal surface of the workpiece W to facilitate movement of the laser cleaning head 200, thereby guaranteeing uniform cleaning operation with respect to the overall metal surface.

Further, the laser cleaning head 200 further includes a metal detection sensor 270 disposed near the distal end of the guide bar 260. The metal detection sensor 270 detects whether the workpiece W is a metal. Preferably, the metal detection sensor 270 is an inductive sensor. The inductive sensor generates a magnetic field in an internal coil to generate an induced current in a metallic material adjacent thereto by the magnetic field, so that impedance of the coil is changed by the induced current. The inductive sensor recognizes such change in impedance as a metal detection signal. In principle, since distinction between metals and non-metals is clear, the inductive sensor has an advantage of accurately recognizing objects, such as general air, insulators, and people, which are not metals.

When the metal detection sensor 270 detects the surface of the workpiece as a metal surface, the controller 120 controls the laser generator 130 to oscillate a laser beam. In addition, when the metal detection sensor 270 does not detect the surface of the workpiece as a metal surface, the controller 120 guarantees safety of operators and the surroundings of the operators by fundamentally blocking oscillation of the laser beam from the laser generator 130. The height of the metal detection sensor 270 is set to be separated a distance of 1 cm to 5 cm from the surface of the workpiece in order to secure sufficient sensitivity while preventing contamination.

During the laser cleaning operation, a large amount of dust is generated on the surface of the workpiece. In particular, in the case of paint cleaning, a large amount of toxic dust is generated. When such dust is effectively collected, safety of an operator can be guaranteed while preventing contamination of optical components in the laser cleaning head 200.

A side surface of the guide bar 260, particularly a side surface of the movable part 264 is provided with a dust collection port 265, which is connected to a dust connection hose 420 connected to a dust collector 400. The dust collector 400 collects dust, which is generated in the course of laser cleaning, through the duct collection hose 420 connected to the dust collection port 265. In order to secure sufficient dust collection, it is important for the dust collection port 265 to have a sufficient diameter. Preferably, the dust collection port 265 has a diameter of 5 cm or more.

An operator holds the laser cleaning head 200 by hand in order to perform the cleaning operation. Thus, in order to allow easy handling of the laser cleaning head 200 by the operator, the laser cleaning head 200 has a light weight. To this end, the head housings 212, 214 of the laser cleaning head 200 are preferably formed of a plastic material. Preferably, the laser cleaning head 200 has a total weight of 3 kg or less to secure workability of operators.

In addition, the first part 212 of the head housings 212, 214, that is, a portion near the handle, is provided with an ON/OFF switch 217. The ON/OFF switch is preferably a button or a trigger.

Further, the focal lens 240 mounted on the laser cleaning head 200 preferably has a focal length of 150 mm to 600 mm. When the focal lens has too close a focal length of less than 150 mm, optical components in the laser cleaning head 200 can be easily contaminated due to dust generated during the cleaning operation, and when the focal lens has too long a focal length of greater than 150 mm, the laser beam can have too large a spot size to provide sufficient laser intensity, thereby making it difficult to perform an effective laser cleaning operation.

When laser cleaning technology is applied to industrial manufacturing sites, mobility of the laser cleaning device is a very important issue. Accordingly, as shown in FIG. 1, the main body 100 including the laser generator 130, the controller 120 and the power supply unit 110 may be loaded on the movable cart 10 or each of the laser generator 130, the controller 120 and the power supply unit 110 may be loaded thereon, thereby enabling easy movement of the manual laser cleaning device by moving the movable cart 10.

At ship manufacturing sites, laser cleaning is frequently performed inside a ship. In this case, since it is not easy to move the main body 100 including the laser generator 130, the controller 120 and the power supply unit 110 to the movable cart including wheels, there is a need for an operator to enter a work site with the main body 100 of the laser cleaning device carried by hand or on the shoulder.

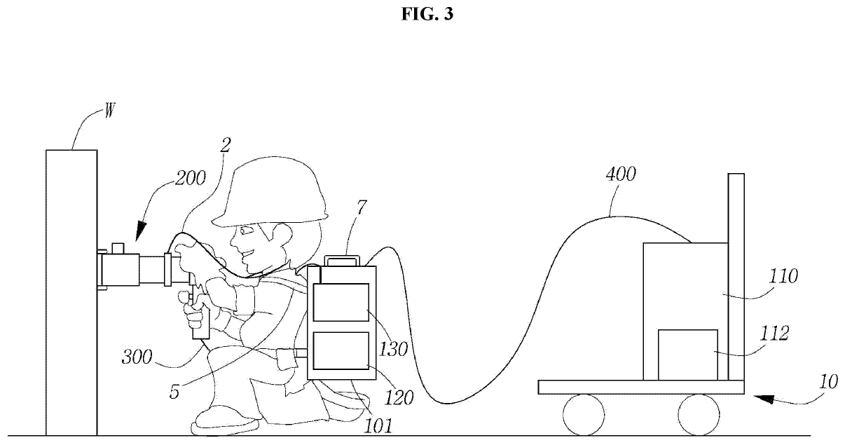

FIG. 3 is a diagram of a manual laser cleaning device according to another embodiment of the invention, which includes a portable laser cleaning module including a laser generator and a controller and adapted to allow an operator to carry the portable laser cleaning module by hand or on the shoulder when entering a work site.

Referring to FIG. 3, the manual laser cleaning device according to this embodiment is provided therein with a laser generator 130 and a controller 120 and includes a portable laser cleaning module 101 adapted to allow an operator to carry the portable laser cleaning module on the shoulder or by hand. In order to allow the operator to carry the portable laser cleaning module 101 on the shoulder, the portable laser cleaning module 101 is provided with a shoulder strap 5. In addition, in order to allow the operator to carry the portable laser cleaning module 101 by hand, the portable laser cleaning module 101 is provided at an upper end thereof with a handle 7.

The manual laser cleaning device according to this embodiment further includes a power supply unit 110 mounted on the movable cart 10. Since the power supply unit 110 is heavy, it is desirable that the power supply unit 110 be mounted on the movable cart 10 instead of being received inside the portable laser cleaning module 101. A power cable 400 having a sufficient length is disposed between the power supply unit 110 and the portable laser cleaning module 101 mounted on the movable cart 10 and the power supply unit 110 supplies power to the portable laser cleaning module 101 through the power cable 400. In recent years, due to remarkable improvement in battery performance, the power supply unit 110 may employ a battery 112. The power cable 400 may be adjusted in length according to an operation environment and may have a length of 10 m or more for efficient operation.

As in the above embodiment, the manual laser cleaning device according to this embodiment includes a laser cleaning head 200 that receives a laser beam transmitted from the laser generator 110 through an optical fiber 300 and irradiates a metal surface of a workpiece with the received laser beam. The laser cleaning head 200 has substantially the same configuration as that of the above embodiment and detailed description thereof will be omitted to avoid repeated description.

When an operator performs a laser cleaning operation using the laser cleaning head 200 for a long period of time in a state of holding the laser cleaning head 200 by hand, the operator can suffer significant fatigue. In order to reduce such fatigue, the manual laser cleaning device according to this embodiment further includes a neck strap 2 connected to the laser cleaning head 200 to hang the laser cleaning head 200 on the neck of the operator. When the operator performs the laser cleaning operation with the neck strap 2 hung on the neck of the operator and connected to the laser cleaning head 200, the weight of the laser cleaning head 200 can be distributed to allow the operator to perform the laser cleaning operation under more convenient conditions.

As a result, when the laser cleaning operation is manually carried out, the manual laser cleaning device according to the present invention can maintain a constant focal location to allow stable cleaning operation and can fundamentally block delivery of a laser beam to a location outside a metal workpiece while effectively collecting detrimental dust, thereby enabling safe cleaning operation.

It should be understood that the present invention can be applied to any manufacturing sites using a laser cleaning process.

Although some embodiments have been described herein, it should be understood by those skilled in the art that these embodiments are given by way of illustration only and the present invention is not limited thereto and that various modifications, variations, and alterations can be made by those skilled in the art without departing from the spirit and scope of the present invention.

1. A manual laser cleaning device for removing foreign matter from a surface of a workpiece, the manual laser cleaning device comprising:
a laser generator configured to oscillate a laser beam;
a controller configured to control the laser generator; and
a laser cleaning head configured to receive the laser beam emitted from the laser generator through an optical fiber and irradiate a surface of a workpiece (W) with the received laser beam, the laser cleaning head comprising:
a head housing having a handle;
a collimator placed in the head housing and configured to collimate the laser beam scattered at one end of the optical fiber into parallel light;
a high-speed Galvano scanner configured to scan the laser beam transmitted through the collimator at high speed using a mirror mounted on a scanning motor; and
a focal lens configured to focus the laser beam scanned by the high-speed Galvano scanner at a focal distance (d) and irradiate the surface of the workpiece with the laser beam.

2. The manual laser cleaning device according to claim 1, wherein the laser cleaning head comprises a metal detection sensor configured to detect whether the surface of the workpiece is a metal surface and the controller blocks oscillation of the laser beam by the laser generator upon detecting that the surface of the workpiece is not the metal surface.

3. The manual laser cleaning device according to claim 1, wherein the laser cleaning head further comprises a laser beam guide bar coupled to the head housing to guide the laser beam focused at the focal distance by the focal lens.

4. The manual laser cleaning device according to claim 3, wherein the laser beam guide bar is adjustable in length according to the focal lens.

5. The manual laser cleaning device according to claim 3, wherein the laser beam guide bar is provided on a side surface thereof with a dust collection port, the dust collection port being connected to a dust connection hose connected to a dust collector.

6. The manual laser cleaning device according to claim 3, wherein the laser cleaning head further comprises a bearing wheel coupled to the laser beam guide bar and rolling along the surface of the workpiece.

7. The manual laser cleaning device according to claim 1, wherein the head housing is formed of a plastic material.

8. The manual laser cleaning device according to claim 1, wherein the high-speed Galvano scanner is configured to be operated in a 2D scanning manner using two scanning motors and two mirrors.

9. The manual laser cleaning device according to claim 1, wherein the laser generator and the controller are integrated into one portable laser cleaning module capable of being carried by an operator through a handle or a shoulder strap, the portable laser cleaning module being connected to a power supply unit through a power cable therebetween.

10. The manual laser cleaning device according to claim 1, wherein the laser cleaning head further comprises a protective window disposed in a region behind the focal lens to protect the focal lens and optical components placed in front of the focal lens, and the focal lens is an f-θ lens.

11. The manual laser cleaning device according to claim 1, wherein the laser generator and the controller are mounted together with the power supply unit on a movable cart.
